(19) United States
(12) Patent Application Publication
(10) Pub. No.: US 2004/0210758 A1
(43) Pub. Date: Oct. 21, 2004

(54) Internet security system utilizing an user ID card reader integrated type keyboard

(76) Inventors: Hyoung Kil Jang, Seoul (KR); Beang Youn Yang, (US); Mun Hyun Choi, Seoul (KR)

Correspondence Address: Eugene Oak, Ph.D., J. D., Patent Attorney, 610 S. Van Ness Ave., Los Angeles, CA, 90005, US

(21) Appl. No.: 10/418,824

(22) Filed: Apr. 21, 2003

(51) Int. Cl. H04L 9/32

(52) U.S. Cl. 713/185; 713/202

(57) ABSTRACT

A novel computer security system for preventing unauthorized users, children for example, from accessing both a personal computer and Internet web sites, comprising: 1) a smart card containing a user's information; 2) a keyboard which read the user's information from the card and compares it with registered user information; and 3) a central server, located at a separate remote site, which identifies the user's information and controls access to web sites.

The present invention relates to a simple method for prohibiting unauthorized users from accessing a personal computer and web sites.

### BACKGROUND OF THE INVENTION

In public domains, some of the published text, graphics, images, and video clips contain content that some people regard as unpleasant or objectionable. Exposure to such sites by minors may lead to severe developmental disorders. Personal computer users who responsible for such minors need tools to protect them from access and exposure to such offensive web sites.

1. Field of Invention

The present invention relates to a simple method for prohibiting unauthorized users from accessing a personal computer and web sites.

2. Description of the Prior Art

In an effort to provide a user with the ability to screen out objectionable content, web browsers have been updated to enable the user to set rating level preferences within the user's web browser. Some filtering applications have been created that allow user rating level preferences, such as Surf Watch™ from Surf Watch Software, and Cyber Sitter™ from Solid Oak Software, that work in coordination with the browser. By setting rating preferences for a variety of content categories, a user may filter out various contents before the user views the content on the user's display. For each web page that a web browser receives, the web browser or filtering application checks the web page for objectionable content according to the rating preference parameters set by the user. A rating system specifies the dimensions used for labeling, the scale of allowable values on each dimension, and a description of the criteria used in assigning values. For example, the MPAA rates movies in the United States based on a single dimension with allowable values G, PG, PG-13, R, and NC-17. A valid URL identifies each rating system. This enables several services to use the same rating system and refer to it by its identifier. The URL that names a rating system can be accessed to obtain a human-readable description of the rating system. The format of that description is not specified as a standard. As previously described, rated content is currently transmitted across the Web in a manner that allows a browser in conjunction with a filter application to screen objectionable content. Part of the Web infrastructure that allows a browser to screen content consists of a content label mechanism in conjunction with a rating system and rating service.

The current web infrastructure that provides support for rating systems may also be used in association with the rating sensitive requests of the present invention. The Platform for Internet Content Selection (PICS™) specification enables labels (metadata) to be associated with Internet content. The specification was originally designed to help parents and teachers control what children access on the Internet, but it also facilitates other uses for labels, including code signing and privacy. The PICS platform is one on which other rating services and filtering software have been built. Many authors and web site operators offer materials that they realize will not be appropriate for all audiences. They may label their materials to make it easier for filtering software to block access. PICS does not endorse any particular labeling vocabulary. As previously described, rated content is currently transmitted across the Web in a manner that allows a browser, in conjunction with a filter application, to screen objectionable content. The current rating systems may also be used with the present invention to rate the content that is to be blocked from transmission. The Recreational Software Advisory Council (RSAC) is an independent, non-profit organization that empowers the public, especially parents, to make informed decisions about electronic media by means of an open, objective, content advisory system. The RSACi (RSAC on the Internet) system provides consumers with information about the level of sex, nudity, violence, offensive language (vulgar or hate-motivated) in software games and Web sites. To date, the RSACi system has been integrated into Microsoft's browser, Internet Explorer. The RSACi system provides a simple, yet effective rating system for Web sites which both protects children and the rights of free speech of everyone who publishes on the World Wide Web. When a parent sets the levels for their child within a Web browser, they may be offered an option that says, “Do not go to unrated sites.”

U.S. Pat. No. 6,510,458 to Berstis, et al. illustrates a method and system for filtering the content of a web page to be cached as a function of the web browser. A user sets preference parameters that filter web page contents from being stored in the cache. Cache filters take a variety of forms, such as ratings filters, web page identifier filters, and key word filters, which scan accessed contents of a web page for user selected terms. The filtered web page is then blocked from the browser's cache. Conversely, a user sets preference parameters that filter web page contents to override the block from cache preferences and store the filtered web pages that were previously designated as web pages not to be cached.

None of the prior art is effective in prohibiting a minor from accessing harmful Internet sites when the rminor changes the grade setting of the web browser on their personal computer. The present invention effectively protects minors by verifying registered user information through a remotely controlled a browser.

### SUMMARY OF THE INVENTION

A novel computer security system for preventing unauthorized users, children for example, from accessing both a personal computer and Internet web sites, comprising: 1) a smart card containing a user's information; 2) a keyboard which read the user's information from the card and compares it with registered user information; and 3) a central server, located at a separate remote site, which identifies the user's information and controls access to web sites.

### BRIEF DESCRIPTION OF FIGURES

FIG. 1 is a perspective drawing of the system utilizing the security card of this invention.

FIG. 2 is a block diagram showing the components of the security system and their interactions.

FIG. 3 is a logic flow sheet of the security system of this invention.

### DETAILED DESCRIPTION OF THE PREFERRED EMBODIMENTS

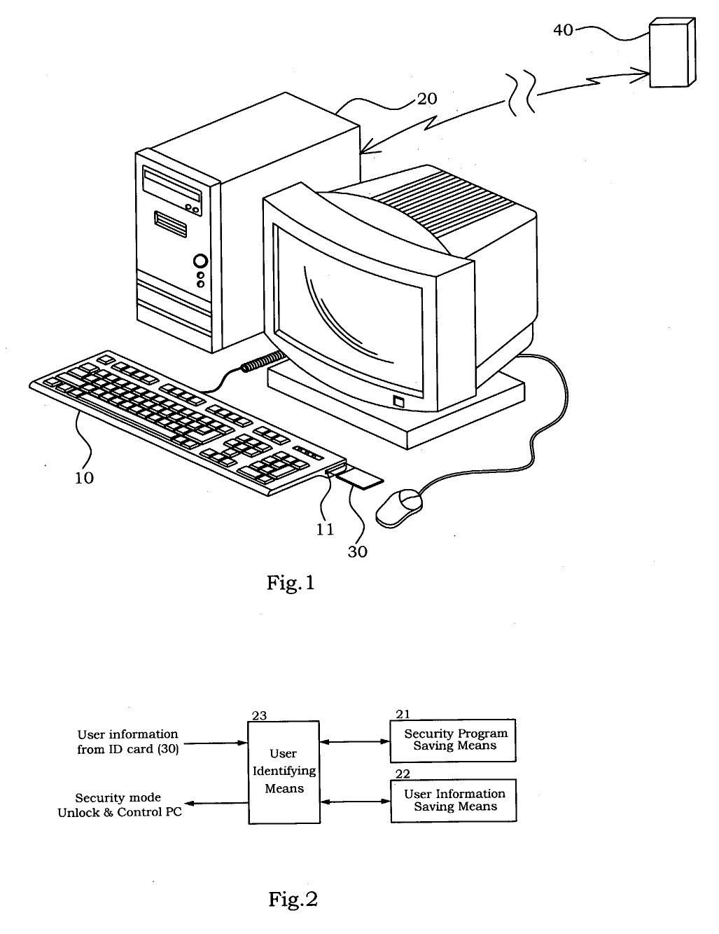

FIG. 1 is a perspective drawing of the system utilizing the security card of this invention. A keyboard (10) houses a card reader (11) which receives a smart card (30) containing user identification (ID) information and a password. Internet access is controlled by a remotely located central server (40) which is connected to the personal computer by a proper means of communication.

FIG. 2 is a block diagram showing the components of the security system and their interactions. The user ID information and password from the smart card (30) are transferred into the computer CPU (23) through the keyboard (10). The user ID and password are then compared with information that has been pre-encrypted in the user information memory (22), which is part of a security program (21) in the hard disk of the CPU (23) of a personal computer (PC) (20). Information for many different users can be encrypted in the user identifying memory (22). If the user ID information matches with a user in the user information memory (22), the user-identifying unit (23) sends a signal allowing the main CPU to be turned on (not shown in this drawing). If the user ID information does not match and of the users in the encrypted memory, then the user-identifying unit (23) does not send a signal to the main CPU.

When a user, identified and authorized, tries to access a particular web site, the web site address and user ID information are first sent to a remotely located central server (40). The central server (40) compares the degree of restriction for the user, which is stored in the user ID information, with the contents of the requested Uniform Resource Locator (URL) and makes a decision as to whether the content is allowable. If the contents are allowable, the main server sends the information from the URL to the user. If the contents are not allowable, the server blocks communication and sends a list of URLs allowable for the user's PC (personal computer) (20).

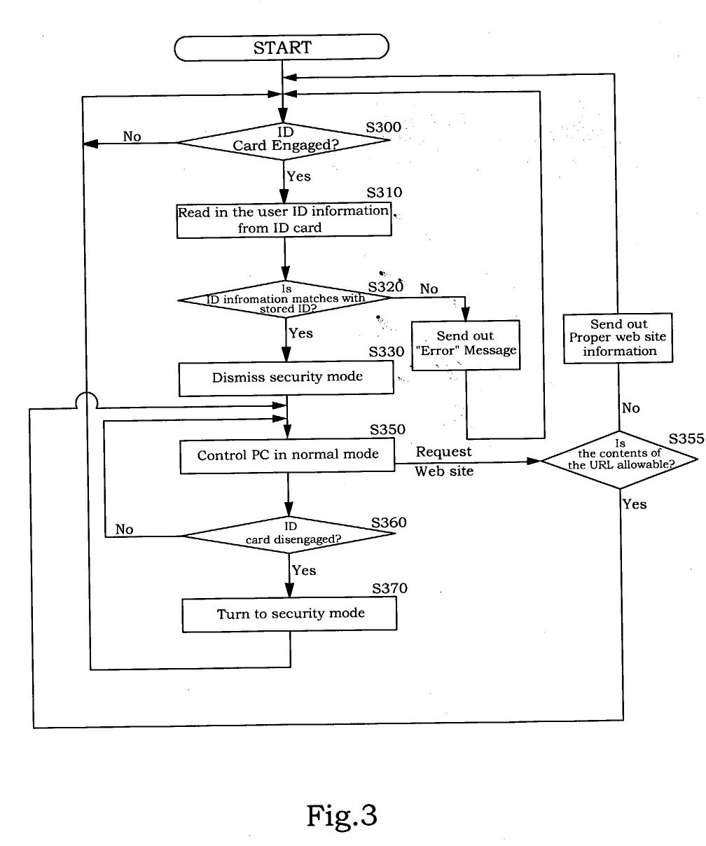

FIG. 3 is a logic flow sheet of the security system of this invention. Basic conditions for this operation are; 1) a security program (21) must be installed in the hard disk; 2) a CPU (23) must execute a user identifying function and; 3) information from at least one user must be encrypted in the user identifying memory (22).

In step S300, the user identifying CPU (23) verifies that a smart card (30) has been inserted into the card reader (11) of the keyboard (10). If a smart card (30) has not been inserted in the card reader (11) of the keyboard, the computer (20) remains in security mode.

In step 310, if a smart card has been inserted into the card reader, the user identifying CPU (23) loads the user information from the user ID information memory (22) and reads the user ID information from the smart card.

In step S320, the CPU (23) compares the user information from the smart card (30) with the information from the user ID information memory (22). If there is no matching ID information, the computer returns to security mode with an “error” message.

However, if the ID information from the smart card (30) matches with the ID information of a user in the memory (22), the security mode is dismissed (step S330).

In step S350, the computer (20) operates with whatever restrictions have been set for the current user ID. The browser being used by the computer will limit the Web sites that can be accessed by the computer.

In step S355, when a user requests a certain web site, both the site URL and user information are sent to a central server (40) first. The central server compares the user ID information with stored information and compares the requested URL's content information with grade information allowed for the user, which is stored in the central server's user information memory. If the contents of the requested URL are within the limits of the restriction allowed for the user of the received ID information, the central server (40) allows access to the requested web site. If the contents of the requested URL traverses the restrictions set for the user of received ID information (e.g. excessive violence and/or sexual content), the central server (40) prevents the browser from displaying the contents of the requested web site. A message recommending web sites within the user's restriction level are then sent to the user's computer (20).

Once the smart card (30) has been disengaged from the card reader (11) (step S360), the main computer (20) activates the security program in the memory (21) (step S370).

What is claimed is;

1. A novel computer security system for preventing unauthorized users, children for example, from accessing both a personal computer and Internet web sites, comprising: 1) a smart card containing a user's information; 2) a keyboard which read the user's information from the card and compares it with registered user information; and 3) a central server, located at a separate remote site, which identifies the user's information and controls access to web sites.
